(19) United States
(12) Patent Application Publication
(10) Pub. No.: US 2006/0110609 A1
(43) Pub. Date: May 25, 2006

(54) Protective coatings

(76) Inventors: Harry E. Eaton, Woodstock, CT (US); Tania Bhatia, Middletown, CT (US); Ellen Y. Sun, South Windsor, CT (US); Thomas H. Lawton, Wethersfield, CT (US)

Correspondence Address: PRATT & WHITNEY, 400 MAIN STREET, MAIL STOP: 132-13, EAST HARTFORD, CT, 06108, US

(21) Appl. No.: 10/992,992

(22) Filed: Nov. 19, 2004

(51) Int. Cl. B32B 13/04; B32B 9/00; B32B 19/00

(52) U.S. Cl. 428/446; 428/701; 428/702; 428/698

(57) ABSTRACT

Protective coatings are described herein. Embodiments of these coatings comprise substantially only specific equilibrium phases therein, and have a CTE that is substantially equal to the CTE of the substrate upon which the coating is deposited. The desired coatings can be obtained by controlling the application of the coating and/or by heat treating the coated substrate to create the desired phases or microstructure in the coating.

### STATEMENT REGARDING FEDERALLY SPONSORED RESEARCH OR DEVELOPMENT

The U.S. Government may have certain rights in this invention pursuant to Contract Number N00014-01-C-0032 with the United States Office of Naval Research.

### FIELD OF THE INVENTION

The present invention relates generally to protective coatings, especially protective coatings for use on gas turbine engine components.

### BACKGROUND OF THE INVENTION

Silicon carbide, silicon nitride, and other silica forming ceramics exhibit accelerated oxidation and recession in high temperature aqueous environments such as those found in combustor and turbine sections of gas turbine engines. It is believed that such material recession occurs because SiO₂ forming materials react with the water vapor at high temperatures, which leads to volatilization of the silica in the form of Si(OH)ₓ. Accordingly, protective coatings such as environmental barrier coatings (EBCs) may be used on components comprising such materials to slow the oxidation and recession and thereby increase the useful service life thereof.

While protective coatings have been developed for use on silicon carbide substrates, these coatings are not acceptable for use on certain monolithic silicon-containing substrates having lower coefficients of thermal expansion than silicon carbide (i.e., silicon nitride). Therefore, it would be desirable to have protective coatings that are capable of being used on silicon-containing substrates having lower coefficients of thermal expansion than silicon carbide. It would also be desirable to have protective coatings that have coefficients of thermal expansion that match those of the substrates they are used on, so as to create stable, crack-free structures. It would be further desirable to have protective coatings that inhibit the formation of volatile silicon species, particularly Si(OH)ₓ, in high temperature, aqueous environments. It would be yet further desirable to have protective coatings that provide thermal protection to the substrates they are used on. It would be even further desirable to have such protective coatings for use on silicon nitride substrates and/or on ceramic matrix composite substrates. It would be still further desirable to have improved methods for selecting suitable protective coatings for various substrates.

Furthermore, steam-stable, coefficient of thermal expansion compatible coatings for ceramic substrates often contain complex silicates, and the coating processes used to deposit these coatings on such substrates often result in amorphous phases and/or metastable phases in the coatings that subsequently change to equilibrium phases during or after use. Such changes may render the coatings unprotective, and therefore, undesirable. Therefore, it would be desirable to ensure that equilibrium phases exist in such coatings, prior to, during and after use, so that optimum protection is provided to the substrate.

### SUMMARY OF THE INVENTION

The above-identified shortcomings of existing protective coatings and methods of selecting same are overcome by embodiments of the present invention, which relates to protective coatings that can be used on various substrates such as silicon-containing substrates having lower coefficients of thermal expansion than silicon carbide. Adjusting the coating chemistry can result in coatings that are appropriate for use on both silicon carbide and silicon nitride substrates. These protective coatings may be utilized on various components, such as, but not limited to, gas turbine engine components.

Embodiments of this invention relate to articles comprising a substrate and a coating disposed on the substrate, the coating comprising predetermined equilibrium phases therein. The article may comprise a gas turbine engine component. In embodiments, the coating may comprise less than about 25 volume percent of non-equilibrium phases. In embodiments, the predetermined equilibrium phases may be crystalline phases and may comprise a 1:1 mole ratio rare-earth-oxide:silica, a 1:2 mole ratio rare-earth-oxide:silica, a rare earth oxide, silica and/or mixtures thereof. In embodiments, the coating may have a coefficient of thermal expansion within about ±1 ppm/° C. of a coefficient of thermal expansion of the substrate.

The coating may comprise a rare earth monosilicate, a rare earth disilicate, a rare earth oxide, silica, and/or mixtures thereof. The coating may comprise a multi-layered protective coating system or a single layer graded protective coating system. The coating may be about 0.1-2000 microns thick.

In some embodiments, the predetermined equilibrium phases may exist in the coating after the coating is deposited. In other embodiments, after the coating is deposited, and prior to first cooling, the article may need to be heat treated to produce the predetermined equilibrium phases in the coating.

In embodiments, the article may further comprise a bond coat between the substrate and the coating, one or more intermediate layers between the bond coat and the coating, a topcoat disposed on the coating, and/or one or more intermediate layers between the coating and the topcoat.

Embodiments of this invention also comprise coated substrates made by depositing a coating on a substrate at a predetermined temperature to create a coated substrate; and heat treating the coated substrate, prior to first cooling, at a time and temperature sufficient to produce predetermined equilibrium crystalline phases in the coating.

In embodiments, the substrate may comprise silicon nitride, and the coating may comprise a yttrium silicate coating comprising about 30-38 mole percent Y₂O₃, balance substantially SiO₂. The yttrium silicate coating may be deposited on the substrate at a temperature of about 1000-1500° C., and then, before first cooling, the coated substrate may be heat treated at about 1100-1600° C. for about 15-600 minutes.

Embodiments of this invention also comprise articles made by thermal spraying a yttrium silicate coating on a silicon nitride substrate at a temperature of about 1250-1300° C. to create a coated substrate; and heat treating the coated substrate at about 1250-1300° C. for about 15-60 minutes prior to first cooling to create equilibrium phases of 1:1 and 1:2 mole ratio Y₂O₃—SiO₂ in the yttrium silicate coating.

Further details of this invention will be apparent to those skilled in the art during the course of the following description.

### DESCRIPTION OF THE DRAWINGS

Embodiments of this invention are described herein below with reference to various figures, wherein like characters of reference designate like parts throughout the drawings, in which:

FIG. 1 is a schematic drawing showing a multiple layered coating system on a substrate, as utilized in embodiments of this invention;

FIG. 2 is a schematic drawing showing a continuously graded coating system on a substrate, as utilized in embodiments of this invention;

FIG. 3 is a graph showing the coefficient of thermal expansion of yttrium silicate as a function of the mole percent Y₂O₃ and SiO₂, as utilized in exemplary embodiments of this invention;

FIGS. 4 is a binary phase diagram showing the yttria-silica system utilized in exemplary embodiments of this invention;

FIG. 5 is an x-ray diffraction pattern of a hot-pressed 36-64 mole percent Y₂O₃—SiO₂ solid body utilized to verify the desirability of a composition utilized in embodiments of this invention;

FIG. 6 is an x-ray diffraction pattern of a 36-64 mole percent Y₂O₃—SiO₂ coating that was thermal sprayed onto a silicon nitride substrate at about 1090° C., then cooled, showing undesirable non-equilibrium phases and amorphous structure therein;

FIG. 7 is an x-ray diffraction pattern of a 36-64 mole percent Y₂O₃—SiO₂ coating that was thermal sprayed onto a silicon nitride substrate at about 1090° C., and then heat treated at a temperature of about 1200° C. for about 1 hour, showing that some of the undesirable amorphous structure converted to undesirable non-equilibrium crystalline phases; and

FIG. 8 is an x-ray diffraction pattern of a 36-64 mole percent Y₂O₃—SiO₂ coating that was thermal sprayed onto a silicon nitride substrate at about 1300° C. and held there for about 1 hour before first cooling, showing substantially only desirable equilibrium phases therein.

### DETAILED DESCRIPTION OF THE INVENTION

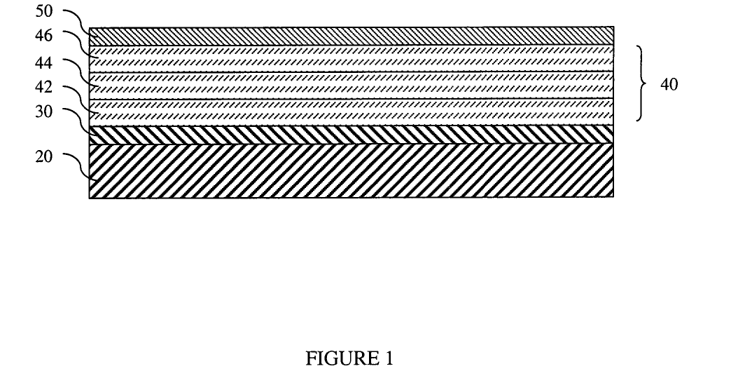

For the purposes of promoting an understanding of the invention, reference will now be made to some embodiments of this invention as illustrated in FIGS. 1-8 and specific language used to describe the same. The terminology used herein is for the purpose of description, not limitation. Specific structural and functional details disclosed herein are not to be interpreted as limiting, but merely as a basis for teaching one skilled in the art to variously employ the present invention. Any modifications or variations in the depicted structures and methods, and such further applications of the principles of the invention as illustrated herein, as would normally occur to one skilled in the art, are considered to be within the spirit and scope of this invention as described and claimed.

This invention relates to protective coatings that comprise substantially only specific equilibrium phases therein. These coatings have a coefficient of thermal expansion (CTE) that is substantially equal to the CTE of the substrate upon which the coatings are deposited. The desired phases and/or CTEs of these coatings can be obtained by controlling the application of these coatings and/or by heat treating the coated substrates to create the desired phases and/or microstructure in the coatings disposed thereon, as more fully described below. A difference of about ±1 ppm/° C. in the CTE between the substrate and the coating will result in a strain of about 0.1% over a temperature range of about 1000° C. The room temperature strain to failure for most brittle materials is about 0.1% in tension. Thus, a brittle ceramic coating will tend to crack on cooling if its CTE differs from that of the substrate by more than about 1 ppm/° C. Therefore, embodiments of these coatings have a CTE that is within about ±1 ppm/° C., more preferably within about ±0.3 ppm/° C., or even more preferably within about ±0.1 ppm/° C., of the CTE of the substrate the coating is used on.

As used herein and throughout, “equilibrium phases” and “equilibrium crystalline phases” refers: (1) to phases that do not change if they are heated to a temperature below the temperature at which they were processed at or quenched from (i.e., about 1500° C. in some embodiments) for an amount of time similar to the expected, intended or actual useful life of the application; (2) to phases that, after fabrication/processing, do not change when exposed to expected, intended or actual application conditions; or (3) to phases that, even if they do change, do not affect the integrity of the coating (i.e., the phases before and after the change have equivalent thermal and physical properties). Trace amounts of impurities may be present in addition to the desired equilibrium phases.

These protective coatings may be used on various substrates as environmental barrier coatings, thermal barrier coatings, and/or as barriers that inhibit the formation of gaseous species of silicon, particularly, Si(OH)ₓ, when exposed to high temperature aqueous (i.e., water, steam) environments such as those found in gas turbine and combustion environments.

Embodiments of these protective coatings comprise any suitable material having the desired equilibrium phases and having a CTE that sufficiently matches that of the substrate. These protective coatings may also comprise minor amounts of impurities (i.e., less than about 10 volume percent) and/or dopants (i.e., less than about 5 volume percent). In some embodiments, these protective coatings comprise rare-earth-silicates (i.e., monosilicates, disilicates, etc.). As used herein and throughout, “rare earth” includes yttrium, scandium, and the lanthanides (lutetium, lanthanum, cerium, praseodymium, neodymium, promethium, samarium, europium, gadolinium, terbium, dysprosium, holmium, erbium, thulium, and ytterbium). In some embodiments, the CTE of the protective coating may be within ±1 ppm/° C. of the CTE of the substrate.

In embodiments, these protective coatings may be utilized as part of a multi-layered protective coating system 40 on a substrate 20, with each layer 42, 44, 46 comprising a different CTE, as shown in one exemplary embodiment in FIG. 1. For example, for silicon carbide based ceramics or ceramic matrix composites, which have a CTE of about 5 ppm/° C., you may use a first layer 42 having a lower CTE (i.e., about 3.5 ppm/° C.), a top layer 46 having a higher CTE (i.e., about 7 ppm/° C.), and a middle layer 44 having an intermediate CTE (i.e., about 6 ppm/° C.). The multi-layered protective coating system 40 may be of any suitable thickness and in embodiments, each layer of the multi-layered protective coating system 40 may be about 0.1-500 microns thick, more preferably about 1-250 microns thick, and even more preferably, about 20-150 microns thick. Any number of layers may be used in the protective coatings 40 of this invention.

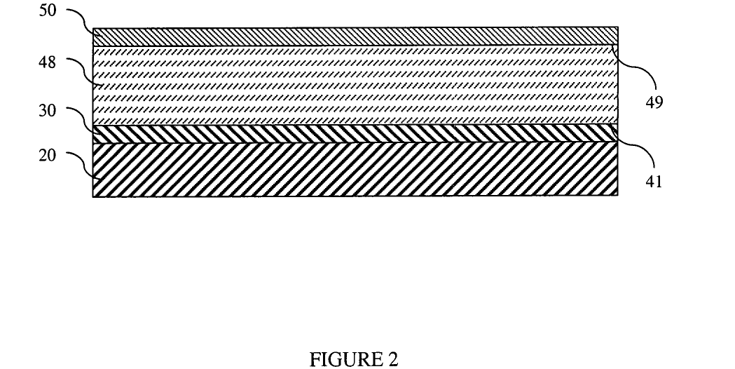

In other embodiments, these protective coatings may comprise a single graded protective coating layer 48 that has a graded composition from one surface to the other, as shown in one exemplary embodiment in FIG. 2. For example, the graded coating 48 may comprise a continuously graded SiO₂—Y₂O₃ coating ranging from about 60-100 mole % SiO₂ (about 0-40 mole % Y₂O₃) near its inner surface 41 to about 45-100 mole % Y₂O₃ (about 0-55 mole % SiO₂) near its outer surface 49. Numerous other grading arrangements are also possible. The graded protective coating may be of any suitable thickness, and in embodiments, may be up to about 2000 microns thick.

These protective coatings may be applied to the substrate 20 in any suitable manner, such as, for example, by thermal spraying (i.e., air plasma spraying, low pressure plasma spraying, high velocity oxy-fuel spraying, combustion spraying, solution spraying, etc.), chemical vapor deposition, physical vapor deposition, electrophoretic deposition, electrostatic deposition, sol-gel, slurry coating, dipping, air-brushing, sputtering, slurry painting, etc. These protective coatings should be applied at a temperature that facilitates the creation of the desired equilibrium phases in the coatings. However these protective coatings are applied, the processing should result in a coating structure having very low stresses (i.e., comprising very low amounts of non-equilibrium phases that may subsequently convert to equilibrium phases and create stresses in the protective coating) so as to avoid cracking or spalling of the coating, etc.

The substrates 20 may comprise any suitable material, such as, for example, silicon-containing substrates (i.e., silicon-containing ceramics, silicon-containing metal alloys, etc.) and fiber reinforced oxide ceramic substrates. Suitable silicon-containing ceramics include, but are not limited to, ceramics containing silicon nitride, silicon carbide, silicon carbide composites, silicon nitride composites, silicon oxynitrides, silicon aluminum oxynitrides, silicon nitride ceramic matrix composites, and fiber reinforced silicon carbide ceramic matrix composites, etc. Suitable silicon-containing metal alloys include, but are not limited to, molybdenum silicon alloys, niobium silicon alloys, iron silicon alloys, cobalt silicon alloys, nickel silicon alloys, tantalum silicon alloys, refractory metal silicide alloys, etc. Suitable fiber reinforced oxide ceramic substrates comprise a ceramic matrix with a reinforcing phase embedded therein and include, but are not limited to, matrices comprising alumina, zirconium oxide, mullite, and/or monazite, etc., reinforced with fibers comprising silicon carbide, silicon nitride, alumina, mullite, monazite, and/or carbon, etc.

In embodiments, a bond coat 30 may be disposed on the substrate 20. This bond coat 30 may comprise any suitable material, such as, for example, silicon, MoSi₂, a refractory metal silicide, a refractory metal, and other refractory metal oxide forming silicides, and/or combinations thereof, etc. These bond coats 30 may be applied to the substrate 20 in any suitable manner, such as, for example, by thermal spray, sputtering, chemical vapor deposition, physical vapor deposition, etc. These bond coats 30 may be of any suitable thickness, and in embodiments, may be about 0.1-250 microns thick, more preferably about 0.5-100 microns thick, and even more preferably, about 1-50 microns thick. Bond coats 30 are typically used on silicon-containing substrates, but may not be needed on fiber reinforced oxide ceramic substrates.

In embodiments, a topcoat 50 may be disposed on the protective coating 40, 48. This topcoat 50 may comprise any suitable material, such as, for example, rare earth oxides, hafnium oxide, zirconium oxide, yttrium oxide, aluminum oxide, tantalum oxide, niobium oxide, mullite, alkaline earth aluminosilicates, barium aluminosilicates, strontium aluminosilicates, titanium oxide, silicon dioxide, rare earth phosphates, aluminium phosphates, and/or combinations thereof, etc. These topcoats 50 may be applied to the protective coating 40, 48 in any suitable manner, such as, for example, by thermal spraying, chemical vapor deposition, physical vapor deposition, electrophorectic deposition, electrostatic deposition, sol-gel, slurry coating, sputtering, dipping, spray painting, etc. These topcoats 40 may be of any suitable thickness, and in embodiments, may be about 1-250 microns thick, more preferably about 10-150 microns thick, and even more preferably, about 20-100 microns thick.

In embodiments, one or more intermediate layers (not shown) may be disposed either between the substrate 20 and the protective coating 40, 48, or between the protective coating 40, 48 and the topcoat 50. Such intermediate layers may provide enhanced adhesion between the substrate 20 and the protective coating 40, 48 and/or between the protective coating 40, 48 and the topcoat 50. Such intermediate layers may also prevent reactions between the substrate 20 and the protective coating 40, 48 and/or between the protective coating 40, 48 and the topcoat 50. These intermediate layers may comprise any suitable materials, such as, for example, SiO₂, mullite, alkaline earth aluminosilicates, barium aluminosilicate, strontium aluminosilicate, barium strontium aluminosilicate, yttrium silicates, calcium aluminosilicate, silicon metal, rare earth oxides, hafnium oxide, zirconium oxide, titanium oxide, yttrium oxide, aluminum oxide, tantalum oxide, niobium oxide, rare earth phosphates, aluminium phosphates, and/or combinations thereof, etc. These intermediate layers may be applied in any suitable manner, such as, for example, by thermal spraying, chemical vapor deposition, physical vapor deposition, sol-gel, slurry coating, electrophoretic deposition, electrostatic deposition, sputtering, dipping, etc. These intermediate layers may be of any suitable thickness, and in embodiments, may be about 1-250 microns thick, more preferably about 10-150 microns thick, and even more preferably, about 20-100 microns thick.

If the desired equilibrium phases do not exist in the coating after it is deposited on the substrate, then the coated substrate can be heat treated to create the desired phases and/or microstructure therein. For example, if the substrate is coated via chemical vapor deposition, the desired equilibrium phases may exist in the coating after it is deposited, so there may be no need for heat treating such coated substrates. However, with other deposition methods, the coated substrates may require heat treatment to create the desired phases/microstructure therein.

The heat treatment may vary according to which coatings, substrates and coating processes are used. In embodiments utilizing a yttrium silicate coating thermally sprayed onto a silicon nitride substrate, the heat treatment may comprise heating the coated substrate to about 1 100-1600° C. for about 15-600 minutes.

Regardless of whether heat treated or not, the final coating should comprise less than about 25 volume percent, more preferably less than about 10 volume percent, and even more preferably less than about 1 volume percent, of non-equilibrium phases in the coating. In embodiments, substantially only equilibrium phases exist in the coating, but dopants (i.e., less than about 5 volume percent) and/or minor impurities (i.e., less than about 10 volume percent) may also be present.

### EXAMPLE

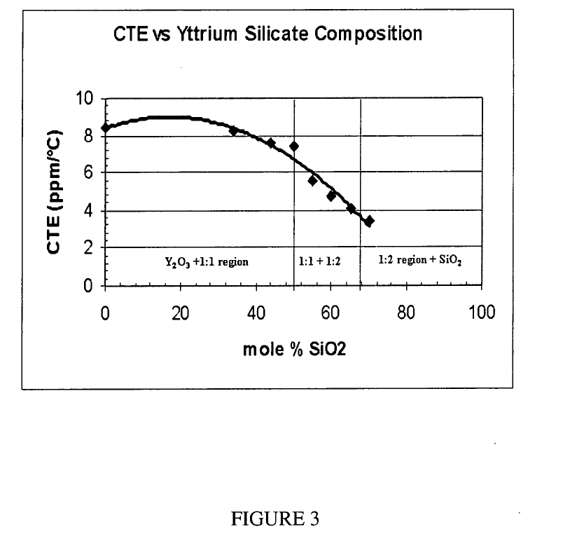

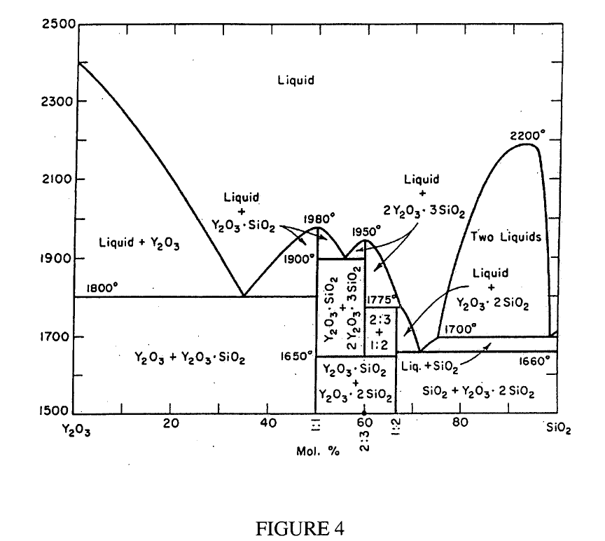

In one exemplary embodiment, a suitable yttrium silicate coating was identified for use on a silicon nitride substrate. Silicon nitride has a CTE of about 3.5 ppm/° C. for room temperature to 1200° C. Since the CTE of yttrium silicate is generally determined by the ratio of yttria and silica present, and by the equilibrium phase content achieved by that ratio of yttria and silica, a yttrium silicate composition having a CTE close to that of the silicon nitride substrate can be selected by referring to FIG. 3, where the effect of the yttria:silica ratio on the CTE of the yttrium silicate composition is shown. For example, as shown in FIG. 3, if a CTE of about 4 ppm/° C. is desired, a composition comprising about 62-66 mole percent silica (SiO₂), or alternatively stated, about 34-38 mole percent yttria (Y₂O₃), is desirable. The yttria-silica phase diagram shown in FIG. 4 can be used to identify the equilibrium phases of yttria and silica that will be present at a given temperature in compositions comprising various mole percents of yttria and silica. When the techniques of this invention are followed to produce a thermodynamically equilibrated structure at room temperature, the phases shown in FIG. 4 for the 1500° C. isotherm are expected to exist at room temperature. Equilibrium crystalline phases are desired because any non-equilibrium crystalline and/or amorphous phases that are present may undergo phase transformations during subsequent processing or upon exposure to high operating temperatures, or they may exhibit CTEs other than those observed for equilibrium phases. Such phase changes may be accompanied by volume changes, which may lead to cracking and disruption of the coating, causing problems similar to the problems encountered when the CTEs of the coating and substrate are mismatched too much.

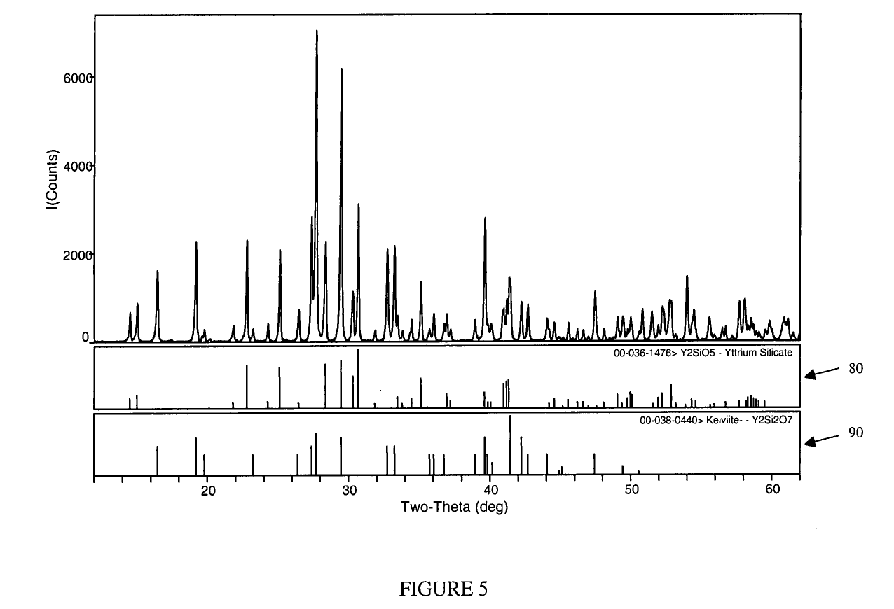

To determine if a 36-64 mole percent Y₂O₃—SiO₂ composition would indeed produce the desired phases in a coating on a silicon nitride substrate, an equilibrated solid body comprising about 36 mole percent Y₂O₃ and about 64 mole percent SiO₂ was fabricated by hot pressing. This solid body had the equilibrated structures indicated in FIG. 5. As seen in the x-ray pattern in FIG. 5, this body exhibited the desirable 1:1 and 1:2 mole ratio phases, 80 and 90 respectively, and had a CTE of about 4 ppm/° C., thereby verifying that the 36-64 mole percent Y₂O₃—SiO₂ composition would be desirable for use as a coating on silicon nitride substrates. This 36-64 mole percent Y₂O₃—SiO₂ composition is also desirable because yttrium silicate exhibits good high temperature steam stability, and its CTE can be adjusted by altering the ratio of yttria and silica present.

Once this suitable 36:64 mole ratio Y₂O₃—SiO₂ composition was verified, a coating comprising the 36:64 mole ratio Y₂O₃—SiO₂ composition was thermal sprayed via air plasma spray onto a silicon nitride substrate to create a coating about 20-150 microns thick. The following thermal spray parameters were used:

| Parameter | Setting |
|---|---|
| Gun | 3M |
| Nozzle | GH |
| Primary gas | Argon |
| Secondary gas | Hydrogen |
| Primary pressure (psi) | 40 |
| Secondary pressure (psi) | 0 |
| Current (amps) | 600 |
| Voltage (volts) | 50 |
| Powder port | #2 - 80 mils |
| Carrier gas | Argon |
| Carrier feed (psi) | 40 |
| Feeder RPM | 3.85 |
| Powder feedrate (g/min) | 12 |
| Stand off (inches) | 4.75 |
| Spray temperature (° C.) | 1300 |
| Cycles | 3 |
| Thickness (mils) | 4-5 |
| Gun speed (inches/second) | 6 |

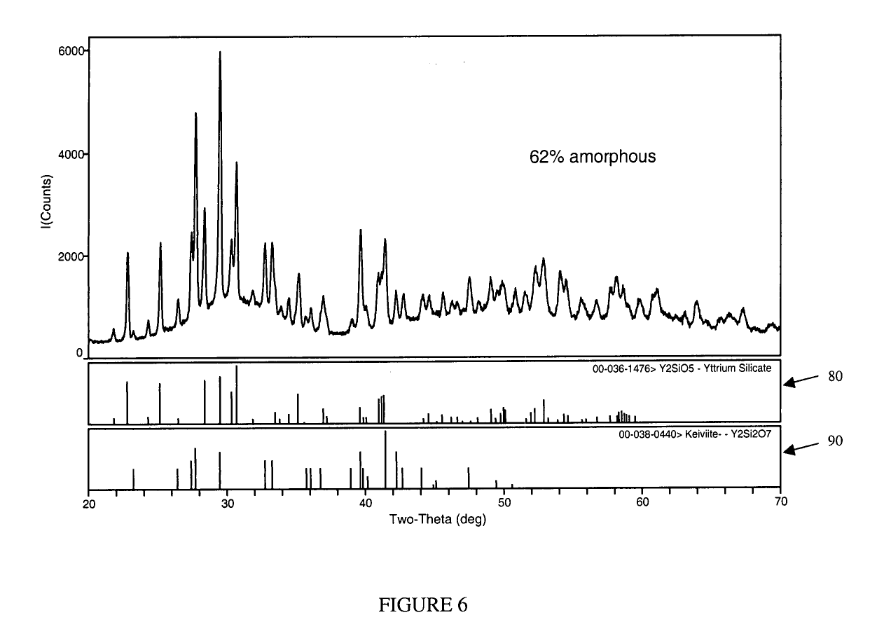

As shown in FIG. 6, this coating exhibited both the 1:1 and 1:2 phases seen in FIG. 5, 80 and 90 respectively, along with a substantial amount (about 62%) of amorphous structure that was not equilibrated. This amorphous phase content is undesirable and very deleterious to the coating integrity since it will exhibit a CTE different from the desired CTE, and will also undergo further phase change on subsequent thermal exposure, both of which will likely lead to cracking and spalling of the coating.

In order to achieve a thermal sprayed 36:64 mole ratio Y₂O₃—SiO₂ coating having the desired phases and CTE, certain critical conditions must be met during fabrication of the coating. Various attempts were made to determine these critical conditions, none of which required undue experimentation.

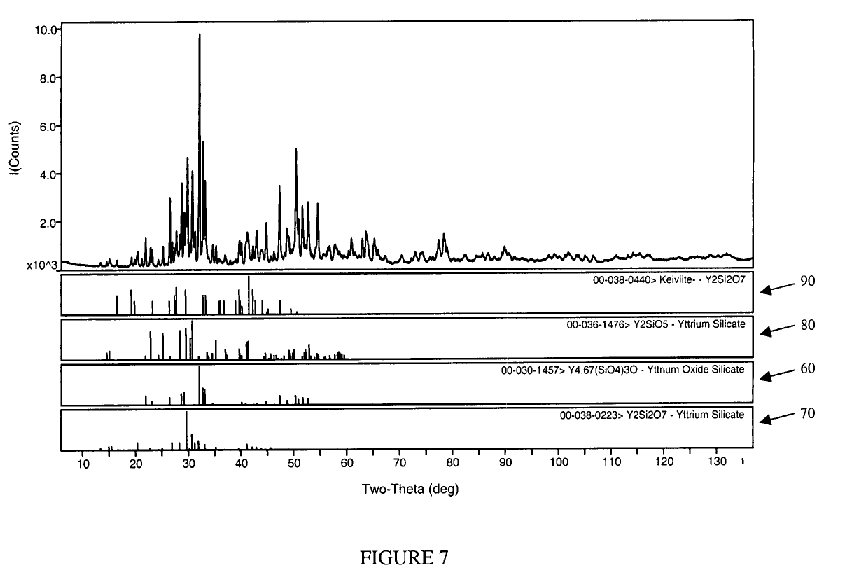

First, the 36:64 mole ratio Y₂O₃—SiO₂ coating was thermal sprayed via air plasma spray onto the silicon nitride substrate using the above-noted spray parameters, but spraying the coating onto the substrate at about 1200° C. and holding the coated substrate at about 1200° C. for about 1 hour before first cooling. Standard x-ray crystallography techniques were then used to identify and/or confirm which phases were present in the final coating. As shown in FIG. 7, this method created a structure having the desirable 1:1 and 1:2 equilibrium phases present, 80 and 90 respectively, with no amorphous content, but also having undesirable non-equilibrium 7:9 and 1:2 mole ratio phases present, 60 and 70 respectively. Therefore, another attempt was made to eliminate these undesirable phases.

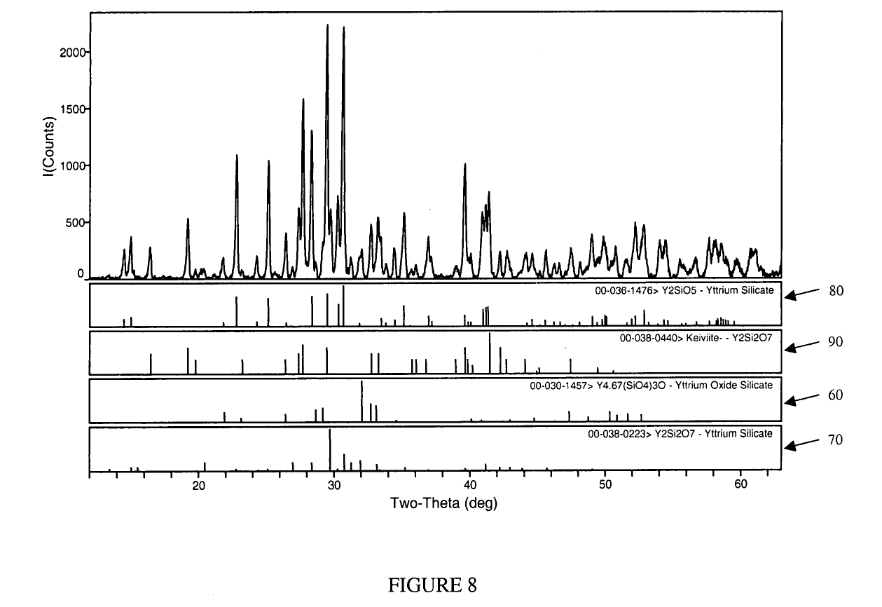

In that regard, a 36:64 mole ratio Y₂O₃—SiO₂ coating was thermal sprayed onto another silicon nitride substrate using the above-noted spray parameters, but this time spraying the coating onto the substrate at about 1300° C. and holding the coated substrate at about 1300° C. for about 1 hour before first cooling. As with the first attempt, standard x-ray crystallography techniques were then used to identify and/or confirm which phases were present in this final coating. As shown in FIG. 8, this method created a structure having substantially only the desirable 1:1 and 1:2 equilibrium phases present, 80 and 90 respectively, with no amorphous content. As can also be seen in FIG. 8, small amounts of the 7:9 mole ratio Y₂O₃—SiO₂ system 60, and variations of the 1:2 mole ratio Y₂O₃—SiO₂ system 70, were also present, but not in detrimental quantities.

These and other trial attempts indicated that this yttrium silicate coating should be deposited on the silicon nitride substrate at a temperature of about 1000-1300° C., more preferably at about 1250-1300° C. They also indicated that this coated substrate should be heat treated at about 1100-1300° C. for about 5-500 minutes, more preferably at about 1250-1300° C. for about 15-60 minutes, to obtain the desired equilibrium phases. They also indicated that heat treating this 36-64 mole percent Y₂O₃—SiO₂ coating/silicon nitride substrate system below about 1250° C. is undesirable because a significant portion of the amorphous portion of the coating converts to the 7:9 mole ratio Y₂O₃—SiO₂ system 60, plus additional variations of the 1:2 mole ratio Y₂O₃—SiO₂ system 70, which creates an overall coating system of 1:1, 7:9 and variations of the 1:2 mole ratio Y₂O₃—SiO₂ systems, as shown in FIG. 7. These 7:9 and variations of the 1:2 mole ratio Y₂O₃—SiO₂ systems, 60 and 70 respectively, are unstable, non-equilibrium phases that do not produce protective coatings that are suitable for use on silicon nitride. These 7:9 and variations of the 1:2 mole ratio Y₂O₃—SiO₂ systems, 60 and 70 respectively, when present in large amounts, result in cracked coatings being formed due to the mismatch between the CTEs of the coating and the substrate.

As described above, this invention provides protective coatings that have desired phases/microstructure therein. In embodiments, these protective coatings have a CTE within about ±1 ppm/° C. of the CTE of the substrate they are used on. While rare-earth-silicate coatings on silicon nitride substrates were described in one exemplary embodiment of this invention, many other coatings and substrates may be utilized with this invention. Suitable coating compositions can be identified for use on various substrates in a manner similar to that just discussed for yttrium silicate coatings on silicon nitride substrates, and all such embodiments are within the scope of this invention, so long as the desired phases are present in the coating. For example, while coatings for substrates having a CTE less than that of silicon carbide were described, the principles of this invention could also be applied to substrates having a CTE greater than that of silicon carbide to determine suitable coatings therefor. These protective coatings may be utilized on gas turbine engine components and other components that operate in high temperature, aqueous environments. Advantageously, these protective coatings function as environmental barriers, thermal barriers, simple oxygen barriers, and/or transition layers. Many other embodiments and advantages will be apparent to those skilled in the relevant art.

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

What is claimed is:

1. An article comprising:
a substrate; and
a coating disposed on the substrate, the coating comprising predetermined equilibrium phases therein.

2. The article of claim 1, wherein the coating comprises less than about 25 volume percent of non-equilibrium phases.

3. The article of claim 1, wherein the predetermined equilibrium phases are crystalline phases.

4. The article of clam 1, wherein the predetermined equilibrium phases comprise at least one of: a 1:1 mole ratio rare-earth-oxide:silica, a 1:2 mole ratio rare-earth-oxide:silica, a rare earth oxide, silica, and mixtures thereof.

5. The article of claim 1, wherein the coating has a coefficient of thermal expansion within about ±1 ppm/° C. of a coefficient of thermal expansion of the substrate.

6. The article of claim 1, wherein the substrate comprises at least one of: a silicon-containing substrate, a silicon-containing ceramic substrate, a silicon-containing metal alloy substrate, and a fiber reinforced oxide ceramic substrate.

7. The article of claim 6, wherein the silicon ceramic substrate comprises at least one of: silicon nitride, silicon carbide, a silicon carbide composite, a silicon nitride composite, a silicon oxynitride, a silicon aluminum oxynitride, a silicon nitride ceramic matrix composite, and a fiber reinforced silicon carbide ceramic matrix composite.

8. The article of claim 6, wherein the silicon-containing metal alloy substrate comprises at least one of: a molybdenum silicon alloy, a niobium silicon alloy, an iron silicon alloy, a cobalt silicon alloy, a nickel silicon alloy, a tantalum silicon alloy, and a refractory metal silicide alloy.

9. The article of claim 6, wherein fiber reinforced oxide ceramic substrate comprises a ceramic matrix with a reinforcing phase embedded therein,
the ceramic matrix comprising at least one of: alumina, zirconium oxide, mullite, and monazite; and
the reinforcing phase comprising at least one of: silicon carbide, silicon nitride, alumina, mullite, monazite, and carbon.

10. The article of claim 1, wherein the coating comprises at least one of: a rare earth monosilicate, a rare earth disilicate, a rare earth oxide, silica, and mixtures thereof.

11. The article of claim 1, wherein the coating comprises at least one of: a multi-layered protective coating system and a graded protective coating system.

12. The article of claim 1, wherein the coating is about 0.1-2000 microns thick.

13. The article of claim 1, wherein the coating is deposited on the substrate via at least one of: thermal spraying, chemical vapor deposition, physical vapor deposition, electrophoretic deposition, electrostatic deposition, sol-gel, slurry coating, dipping, air-brushing, sputtering, and slurry painting.

14. The article of claim 1, wherein after the coating is deposited, the predetermined equilibrium phases exist in the coating.

15. The article of claim 1, wherein after the coating is deposited, and prior to first cooling, the article is heat treated at a time and temperature sufficient to produce the predetermined equilibrium phases in the coating.

16. The article of claim 1, wherein the substrate comprises a silicon nitride substrate and the coating comprises a yttrium silicate coating comprising about 30-38 mole percent Y₂O₃, balance substantially SiO₂.

17. The article of claim 16, wherein the yttrium silicate coating is deposited on the substrate at a temperature of about 1000-1500° C.

18. The article of claim 17, wherein after the yttrium silicate coating is deposited on the silicon nitride substrate, and before first cooling, the article is heat treated at about 1100-1600° C. for about 15-600 minutes.

19. The article of claim 1, the article further comprising at least one of:
a bond coat between the substrate and the coating;
at least one intermediate layer between the bond coat and the coating;
a topcoat disposed on the coating; and
at least one intermediate layer between the coating and the topcoat.

20. The article of claim 19, wherein the bond coat comprises at least one of: silicon, MoSi₂, a refractory metal silicide, a refractory metal, a refractory metal oxide forming silicide, and combinations thereof.

21. The article of claim 19, wherein any intermediate layers comprise at least one of: SiO₂, mullite, an alkaline earth aluminosilicate, a barium aluminosilicate, a strontium aluminosilicate, a barium strontium aluminosilicate, a yttrium silicate, a calcium aluminosilicate, a silicon metal, a rare earth oxide, hafnium oxide, zirconium oxide, titanium oxide, yttrium oxide, aluminum oxide, tantalum oxide, niobium oxide, a rare earth phosphate, an aluminum phosphate, and/or combinations thereof.

22. The article of claim 19, wherein the topcoat comprises at least one of: a rare earth oxide, hafnium oxide, zirconium oxide, yttrium oxide, aluminum oxide, tantalum oxide, niobium oxide, mullite, an alkaline earth aluminosilicate, a barium aluminosilicate, a strontium aluminosilicate, titanium oxide, silicon dioxide, a rare earth phosphate, an aluminium phosphate, and/or combinations thereof.

23. The article of claim 1, wherein the article comprises a gas turbine engine component.

24. A coated substrate made by a process comprising:
depositing a coating on a substrate at a predetermined temperature to create a coated substrate; and
heat treating the coated substrate, prior to first cooling, at a time and temperature sufficient to produce predetermined equilibrium crystalline phases in the coating.

25. The coated substrate of claim 24, wherein the coating is deposited on the substrate via at least one of: thermal spraying, chemical vapor deposition, physical vapor deposition, electrophoretic deposition, electrostatic deposition, sol-gel, slurry coating, dipping, air-brushing, sputtering, and slurry painting.

26. The coated substrate of claim 24, the process further comprising at least one of:
applying a bond coat between the substrate and the coating;
applying at least one intermediate layer between the bond coat and the coating;
applying a topcoat on the coating; and
applying at least one intermediate layer between the coating and the topcoat.

27. An article made by a process comprising:
thermal spraying a yttrium silicate coating on a silicon nitride substrate at a temperature of about 1250-1300° C. to create a coated substrate; and
heat treating the coated substrate at about 1250-1300° C. for about 15-60 minutes prior to first cooling to create equilibrium phases of 1:1 and 1:2 mole ratio Y₂O₃—SiO₂ in the yttrium silicate coating.

28. The article of claim 27, the process further comprising at least one of:
applying a bond coat on the silicon nitride substrate prior to thermal spraying the yttrium silicate coating thereon;
applying at least one intermediate layer between the bond coat and the yttrium silicate coating;
applying a topcoat on the yttrium silicate coating prior to heat treating the coated substrate; and
applying at least one intermediate layer between the yttrium silicate coating and the topcoat.
